(19) United States
(12) Patent Application Publication
(10) Pub. No.: US 2013/0183058 A1
(43) Pub. Date: Jul. 18, 2013

(54) IMAGE FORMING APPARATUS

(71) Applicant: Jung Yun WON, Suwon-si (KR)

(72) Inventor: Jung Yun WON, Suwon-si (KR)

(73) Assignee: Samsung Electronics Co., Ltd., Suwon-si, (KR)

(21) Appl. No.: 13/740,329

(22) Filed: Jan. 14, 2013

(30) Foreign Application Priority Data
Jan. 16, 2012 (KR) 10-2012-0004837

(51) Int. Cl. G03G 15/00

(52) U.S. Cl. CPC G03G 15/80
USPC 399/90

(57) ABSTRACT

An image forming apparatus includes a main body having an opening, and a consumable article separably installed in the main body through the opening. The consumable article includes a connector to perform a connection. The main body includes a connection terminal protruding toward the connector and a guide protrusion to prevent the connection terminal from coming into contact with a portion adjacent to the connector. The consumable article is provided with a guide groove into which the guide protrusion is inserted when the connection terminal and the connector are positioned to correspond to each other. When the connection terminal and the connector reach positions corresponding to each other, the guide protrusion is into the guide groove to perform the connection between the connection terminal and the connector, which prevents friction between the connection terminal and a portion adjacent to the connector.

### CROSS-REFERENCE TO RELATED APPLICATIONS

This application claims priority under 35 U.S.C. §119 from Korean Patent Application No. 2012-0004837, filed on Jan. 16, 2012 in the Korean Intellectual Property Office, the disclosure of which is incorporated herein by reference in its entirety.

### BACKGROUND

1. Field

The present general inventive concept relate to an image forming apparatus in which consumable articles having identification boards are separably installed.

2. Description of the Related Art

Conventional image forming apparatuses are devised to form an image on a printing medium. Examples of image forming apparatuses include printers, copiers, fax machines, and devices combining functions thereof.

The conventional image forming apparatus includes a main body provided at one side thereof with an opening, a cover configured to open or close the opening, and a consumable article, such as a developing unit, separably inserted into the main body through the opening.

In the above-described image forming apparatus, the consumable article includes a consumable article identification board containing a variety of information related to the consumable article. For example, the developing unit includes a developing unit identification board containing information related to the developing unit, such as options and model name of the developing unit, the amount of developer included in the developing unit, etc., but is not limited thereto.

To transmit information contained in the consumable article identification board to the main body, the consumable article identification board is provided with a connector, and a connection terminal protrudes from the main body toward the connector of the consumable article such that the connection terminal comes into contact with the connector as the consumable article is installed within the main body.

The connection terminal protruding from the main body as described above, however, comes into frictional contact with a portion adjacent to the connector of the consumable article as the consumable article moves to be inserted into or separated from the main body. If this friction repeatedly occurs for a long time, connection between the connection terminal and the connector may be unstable due to damage to the connection boss.

### SUMMARY

The present general inventive concept provides an image forming apparatus that maintains a stable connection between a connection terminal of a main body and a connector of a consumable article even after extensive use.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an image forming apparatus including a main body having an opening, and a consumable article separably installed in the main body through the opening, wherein the consumable article includes at least one connector to perform connection, the main body includes a connection unit having at least one connection terminal that protrudes toward the connector of the consumable article so as to come into contact with the connector when the consumable article is installed in the main body, any one of the consumable article and the connection unit is provided with a guide protrusion to prevent the connection terminal from coming into contact with a portion adjacent to the connector, and the other one of the consumable article and the connection unit is provided with a guide groove into which the guide protrusion is inserted when the connection terminal and the connector are positioned to correspond to each other.

The at least one connection terminal may include a plurality of connection terminals arranged in parallel, and the at least one connector may include a plurality of connectors to correspond to the plurality of connection terminals.

The consumable article may be vertically movably installed in the main body.

The guide protrusion may include a pair of guide protrusions extending from the connection unit in both lateral directions of the connection terminal, and the guide groove may be recessed at either side of the connector of the consumable article to correspond to each guide protrusion.

The connection terminal may include an arc-shaped metal plate, and the guide protrusion may have a shape equivalent to the connection terminal and have greater width and height than the connection terminal.

The connection unit may have one end rotatably installed within the main body such that the connection terminal is vertically movable as the connection unit is rotated about the end thereof.

The connection unit may include a hinge protruding from one end thereof and rotatably installed to the main body, and an elastic member to elastically support the connection unit to allow the other end of the connection unit to be moved downward.

The consumable article may further include a consumable article identification board containing information related to the consumable article, and the connector may be provided on the consumable article identification board.

The consumable article may include a developing unit to develop an electrostatic latent image to a visible image.

The foregoing and/or other features and utilities of the present general inventive concept may also be achieved by providing an image forming apparatus, including a main body, a connection unit rotatably coupled to the main body and including at least one connection terminal to receive information to be provided to the main body, and a consumable article to rotate the connection unit in a first direction during an installation of the consumable article within the main body and to rotate the connection unit in a second direction during a completion of the installation such that the at least one connection terminal does not contact the consumable article until the connection unit rotates in the second direction.

The information may be transferred from the consumable article to the at least one connection terminal upon contact between the at least one connection terminal and the consumable article.

The at least one connection terminal may be elastically deformable and may move upward upon contact with the consumable article.

The connection unit may further include at least one guide protrusion to contact the consumable article.

The consumable article may include at least one guide groove formed therein to correspond to and receive therein the at least one guide protrusion.

The at least one guide groove may receive the at least one guide protrusion during the second directional rotation of the connection unit.

The at least one connection terminal may not contact the consumable article until at least a portion of the at least one guide protrusion is received within the at least one guide groove.

The consumable article may include at least one connector to contact the at least one connection terminal to transfer the information from the consumable article to the main body.

The rotations of the connection unit in the first and second directions may both occur as the consumable article is pushed in a first installation direction within the main body.

The image forming apparatus may further include an elastic member to provide a rotational force to the connection unit such that the connection unit rotates in the second direction and the at least one connection terminal maintains contact with the consumable article after installation of the consumable article within the main body.

The elastic member may be disposed at a first end of the connection unit opposite to a second end at which the connection unit contacts the consumable article.

The foregoing and/or other features and utilities of the present general inventive concept may also be achieved by providing an image forming apparatus, including a main body, a connection unit rotatably coupled to the main body, including at least one connection terminal to receive information to be provided to the main body, and one of a guide groove and a guide protrusion, and a consumable article to rotate the connection unit in a first direction during an installation of the consumable article within the main body, the consumable article including the other one of the guide groove and the guide protrusion, such that the consumable article transfers the information to the at least one connection terminal in response to an insertion of the guide groove into the guide protrusion.

The insertion of the guide groove into the guide protrusion may cause the at least one connection terminal to contact the consumable article.

The guide groove may be inserted into the guide protrusion during a rotation of the connection unit in a second direction.

The first rotational direction of the connection unit may be counter-clockwise and the second rotational direction of the connection unit may be clockwise.

The foregoing and/or other features and utilities of the present general inventive concept may also be achieved by providing an image forming apparatus, including a main body, a consumable article to be installed within the main body in a first installation direction, and a connection unit rotatably coupled to the main body, the connection unit including at least one connection terminal to receive information from the consumable article to be provided to the main body, and a guide protrusion to prevent the at least one connection terminal from contacting the consumable article until the guide protrusion is received within a guide groove within the consumable article during the installation of the consumable article in the first installation direction.

The connection unit may rotate in a first direction before the guide protrusion is received within the guide groove and may rotate in a second direction in response to the guide protrusion being received within the guide groove.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a sectional view of an image forming apparatus according to an exemplary embodiment of the present general inventive concept;

FIG. 2 is a perspective view of the image forming apparatus according to an exemplary embodiment of the present general inventive concept;

FIG. 3 is a perspective view illustrating a developing unit and a connection unit of the image forming apparatus according to an exemplary embodiment of the present general inventive concept; and

FIGS. 4 through 6 are side views illustrating a connection procedure of a connector of the developing unit and the connection unit of a main body in the image forming apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

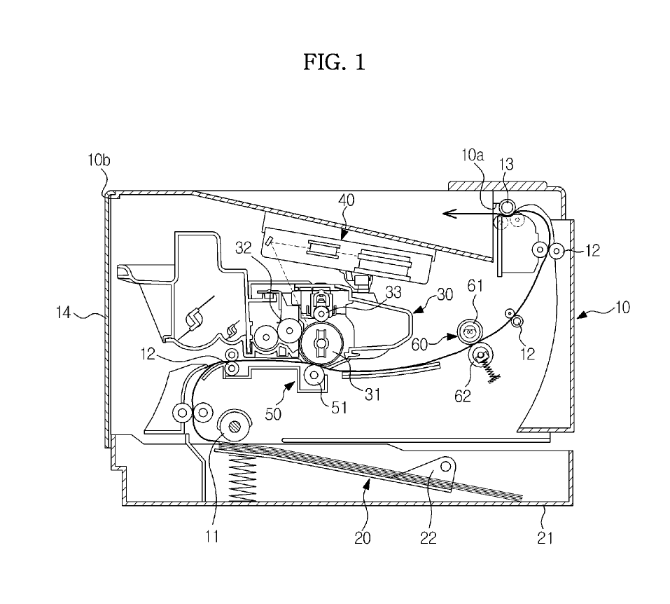

The image forming apparatus according to an exemplary embodiment of the present general inventive concept, as illustrated in FIG. 1, includes a main body 10 defining an external appearance thereof, a printing media supply unit 20 to supply printing media, a developing unit 30 to develop an electrostatic latent image into a visible image using developer, an exposure unit 40 to form the electrostatic latent image by irradiating light to a photoconductor 31 of the developing unit 30, a transfer device 50 to transfer the visible image formed on the photoconductor 31 of the developing unit 30 to a printing medium, and a fixing device 60 to fix the transferred developer to the printing medium.

The main body 10 has a printing media discharge opening 10a, through which the printing medium on which an image has been completely formed is discharged. Arranged above the printing media supply unit 20 within the main body 10 are a pickup roller 11 to pick up printing media loaded on a knock-up plate 22, delivery rollers 12 to guide the printing media picked up by the pickup roller 11 upward, and a discharge roller 13 that is located inside the discharge opening 10a to outwardly discharge the printing media having passed through the fixing device 60 from the discharge opening 10a.

The printing media supply unit 20 includes a printing media cassette 21 movably installed to the main body 10, and the knock-up plate 22 placed in the printing media cassette 21 such that printing media is loaded on the knock-up plate 22.

The developing unit 30 includes the photoconductor 31 on which the electrostatic latent image is formed by the exposure unit 40, a developing roller 32 to feed developer to the photoconductor 31, and a charging roller 33 to charge a surface of the photoconductor 31.

The exposure unit 40 forms the electrostatic latent image on the surface of the photoconductor 31 by irradiating light containing image information to the photoconductor 31 of the developing unit 30.

The transfer device 50 includes a transfer roller 51 to transfer the visible image formed on the photoconductor 31 to the printing medium.

The fixing device 60 includes a heating roller 61 that generates heat, and a pressure roller 62, an outer peripheral surface of which is formed of an elastically deformable material, the pressure roller 62 serving to press the printing medium against the outer peripheral surface of the heating roller 61.

Among the aforementioned components, the developing unit 30 stores developer therein, and is a consumable article to be replaced after the stored developer is completely consumed.

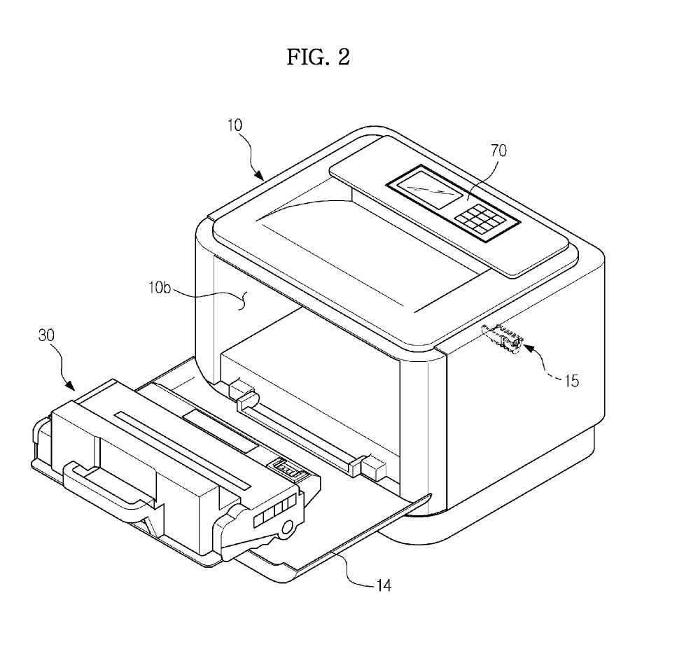

To replace the consumable article, such as the developing unit 30, the main body 10, as illustrated in FIG. 2, includes an opening 10b formed in one side thereof, and a cover 14 pivotally coupled to a lower end of the opening 10b to open or close the opening 10b.

The consumable article, such as the developing unit 30, may include a consumable article identification board containing information related to the consumable article therein. When the consumable article is mounted in the main body 10, the consumable article identification board may be connected to a main circuit board (not illustrated), etc. provided in the main body 10 to permit transmission of the information related to the consumable article to the main circuit board.

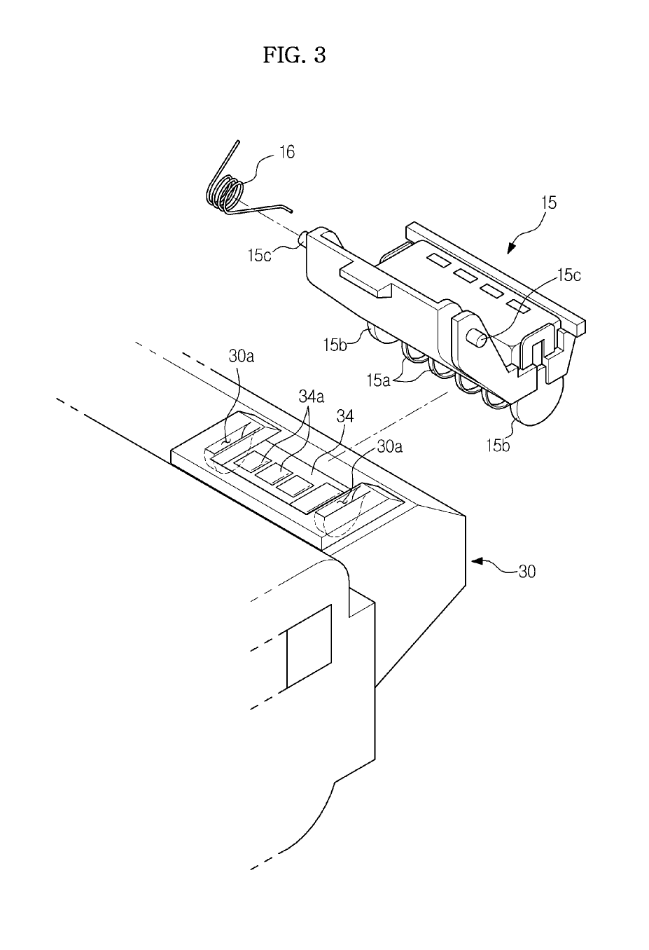

Referring to FIGS. 2 and 3, a configuration of connecting a developing unit identification board, which is provided within the developing unit 30 as the consumable article identification board, to the main body 10 will be described.

The developing unit 30 develops the electrostatic latent image into the visible image using developer. As illustrated in FIG. 3, the developing unit 30 includes a developing unit identification board 34 containing a variety of information related to the developing unit 30. The main body 10 includes a connection unit 15 having connection terminals 15a to be connected to the developing unit identification board 34 of the developing unit 30 when the developing unit 30 is inserted into the main body 10.

The developing unit identification board 34 includes connectors 34a exposed upward with respect to the developing unit 30 to be connected to the respective connection terminals 15a of the connection unit 15.

The connection unit 15 is placed inside the opening 10b of the main body 10 and is located above the connectors 34a of the developing unit 30 inserted into the main body 10. The connection terminals 15a protrude downward from a lower surface of the connection unit 15 and are connected to the connectors 34a of the developing unit 30 below the connection unit 15. As such, when the developing unit 30 is inserted into the main body 10, the connectors 34a are connected to the connection terminals 15a, which may permit transmission of information contained in the developing unit identification board 34 to the main body 10.

The connection terminals 15a may be metal plates that are elastically deformable and bent in an arc shape. The plurality of connection terminals 15a is installed to the connection unit 15 to be arranged in parallel and protrude toward the developing unit identification board 34. The plurality of connectors 34a is arranged in parallel on the developing unit identification board 34 to correspond to the respective connection terminals 15a. As such, the connection terminals 15a are vertically movable to be connected to or disconnected from the connectors 34a as the developing unit 30 is coupled to or separated from the main body 10, respectively.

To enable vertical movement of the connection terminals 15a as described above, the connection unit 15 is rotatably installed within the main body 10 via a hinge 15c protruding from one end thereof. Accordingly, the connection terminals 15a are vertically movable as the connection unit 15 rotates about the hinge 15c. An elastic member 16 in the form of a torsion spring, for example, may be coupled to the hinge 15c to elastically support the connection unit 15 to maintain a connection between the connection terminals 15a and the connectors 34a.

To prevent damage to the connection terminals 15a due to friction with portions adjacent to the connectors 34a when the developing unit 30 is coupled to or separated from the main body 10, the connection unit 15 is provided with guide protrusions 15b and the developing unit 30 is provided with guide grooves 30a corresponding to the guide protrusions 15b.

More specifically, the two guide protrusions 15b have a shape similar to the connection terminals 15a, but may have a greater width and height than the connection terminals 15a, and are arranged at both lateral sides of the connection terminals 15a. The two guide grooves 30a have a width and depth equivalent to those of the guide protrusions 15b and are recessed at both lateral sides of the connectors 34a. As such, the guide protrusions 15b are inserted into the guide grooves 30a when the connection terminals 15a and the connectors 34a are arranged to correspond to each other, whereby a connection between the connection terminals 15a and the connectors 34a is accomplished.

A user interface 70 may be provided on the main body 10 in order to allow a user to choose whether or not the information is transferred from the developing unit 30 to the main body 10. More specifically, the under interface 70 may include any combination of a touch-screen, display screen, keypad, etc., but is not limited thereto, in order to allow a user to view the information and/or status corresponding to the newly installed developing unit 30.

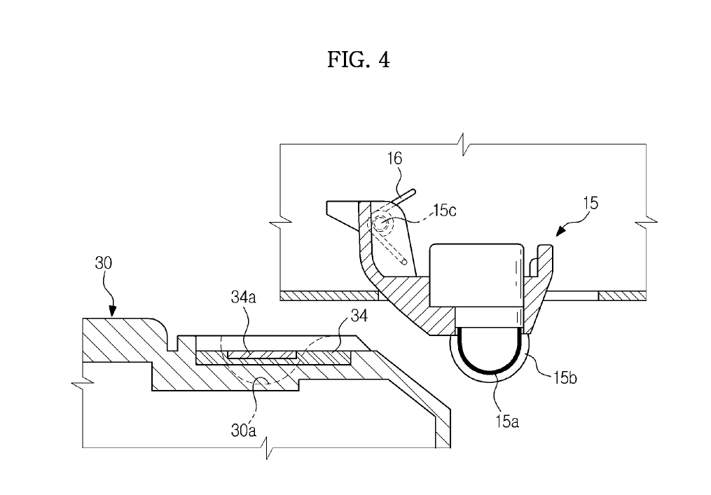

Referring to FIGS. 4 through 6, a connecting procedure of the connection terminals and the connectors will be described in detail.

First, before the developing unit 30 is inserted into the main body 10, as illustrated in FIG. 4, the connection unit 15 remains rotated clockwise by a certain angle by elasticity of the elastic member 16, and the connection terminals 15a remain extended downward.

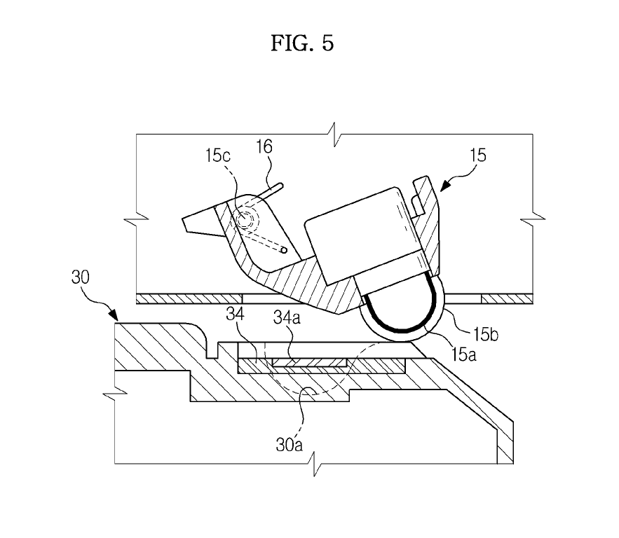

While the developing unit 30 is inserted into the main body 10 and is moved inward corresponding to the main body 10, the guide protrusions 15b, as illustrated in FIG. 5, are supported and pressed by portions adjacent to the connectors 34a of the developing unit 30. As the elastic member 16 is elastically deformed by a force resulting from the guide protrusions 15b being pressed against the portions adjacent to the connectors 34a, the connection unit 15 is rotated counterclockwise about the hinge 15c formed at one end thereof, whereby the other end of the connection unit 15 also rotates and the connection terminals 15a are moved upward.

In such a state, since the guide protrusions 15b, which are arranged at both lateral sides of the connection terminals 15a and have greater width and height than the connection terminals, are supported by portions of the developing unit 30 adjacent to the connectors 34a, the connection terminals 15a are spaced apart from the portions of the developing unit 30 adjacent to the connectors 34a. This may prevent frictional contact between the connection terminals 15a and the portions adjacent to the connectors 34a while the developing unit 30 is inserted into and moved inside the main body 10.

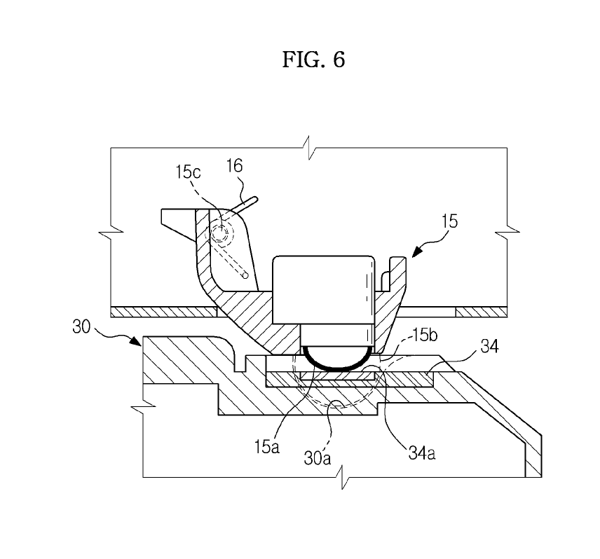

Movement of the developing unit 30 is continued until the connectors 34a reach positions corresponding to the connection terminals 15a. Once the connectors 34a and the connection terminals 15a are positioned to correspond to each other, the guide protrusions 15b and the guide grooves 30a are also positioned to correspond to each other. As such, the connection unit 15, as illustrated in FIG. 6, is rotated clockwise by elasticity of the elastic member 16, whereby the guide protrusions 15b are inserted into the guide grooves 30a. This allows the connection terminals 15a installed within the connection unit 15 to be connected to the connectors 34a via downward movement thereof. That is, the connection terminals 15a come into contact with only the connectors 34a and do not cause friction with the portions adjacent to the connectors 34a. Also as illustrated in FIG. 6, the connection terminals 15a may move upward due to their elastic deformability, in order to maintain a constant connection with the connectors 34a.

Although FIGS. 4 through 6 illustrate the guide protrusions 15b as being formed at the connection unit 15 and the guide grooves 30a as being formed at the developing unit 30, there may also be other embodiments in which the guide protrusions 15b are formed at the developing unit 30 and the guide grooves 30a are formed at the main body 10 or the connection unit 15.

Although FIGS. 1 through 6 illustrate a main body 10 and a connection configuration between the developing unit identification board 34 included in the developing unit 30 that is separably coupled to the main body 10, the present general inventive concept is not limited thereto, and may be applied to the main body 10 and a connection configuration between any type of consumable article identification boards of various other consumable articles that may be separably coupled to the main body 10. Other consumable articles may include developing rollers, ink cartridges, toner cartridges, fusing rollers, etc., but are not limited thereto.

As is apparent from the above description, according to exemplary embodiments of the present general inventive concept, when connection terminals and connectors reach positions corresponding to each other, guide protrusions are inserted into guide grooves, and connection between the connection terminals and the connectors is accomplished without friction between the connection terminals and portions adjacent to the connectors.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a main body having an opening; and
a consumable article separably installed in the main body through the opening,
wherein the consumable article includes at least one connector to perform a connection,
wherein the main body includes a connection unit having at least one connection terminal that protrudes toward the connector of the consumable article so as to come into contact with the connector when the consumable article is installed in the main body,
wherein any one of the consumable article and the connection unit is provided with a guide protrusion to prevent the connection terminal from coming into contact with a portion adjacent to the connector, and
wherein the other one of the consumable article and the connection unit is provided with a guide groove into which the guide protrusion is inserted when the connection terminal and the connector are positioned to correspond to each other.

2. The apparatus according to claim 1,
wherein the at least one connection terminal includes a plurality of connection terminals arranged in parallel, and
wherein the at least one connector includes a plurality of connectors to correspond to the plurality of connection terminals.

3. The apparatus according to claim 1,
wherein the connection terminal is vertically movably installed in the main body.

4. The apparatus according to claim 3,
wherein the guide protrusion includes a pair of guide protrusions extending from the connection unit in both lateral directions of the connection terminal, and
wherein the guide groove is recessed at either side of the connector of the consumable article to correspond to each guide protrusion.

5. The apparatus according to claim 4,
wherein the connection terminal includes an arc-shaped metal plate, and
wherein the guide protrusion has a shape equivalent to the connection terminal and has greater width and height than the connection terminal.

6. The apparatus according to claim 3, wherein the connection unit has one end rotatably installed within the main body such that the connection terminal is vertically movable as the connection unit is rotated about the end thereof.

7. The apparatus according to claim 6, wherein the connection unit includes:
a hinge protruding from one end thereof and rotatably installed to the main body; and
an elastic member to elastically support the connection unit to allow the other end of the connection unit to be moved downward.

8. The apparatus according to claim 1,
wherein the consumable article further includes a consumable article identification board containing information related to the consumable article, and
wherein the connector is provided on the consumable article identification board.

9. The apparatus according to claim 1, wherein the consumable article includes a developing unit to develop an electrostatic latent image to a visible image.

10. An image forming apparatus, comprising:
a main body;
a connection unit rotatably coupled to the main body and comprising at least one connection terminal to receive information to be provided to the main body; and
a consumable article to rotate the connection unit in a first direction during an installation of the consumable article within the main body and to rotate the connection unit in a second direction during a completion of the installation such that the at least one connection terminal does not contact the consumable article until the connection unit rotates in the second direction.

11. The image forming apparatus of claim 10, wherein the information is transferred from the consumable article to the at least one connection terminal upon contact between the at least one connection terminal and the consumable article.

12. The image forming apparatus of claim 10, wherein the at least one connection terminal is elastically deformable and moves upward upon contact with the consumable article.

13. The image forming apparatus of claim 10, wherein the connection unit further comprises:
at least one guide protrusion to contact the consumable article.

14. The image forming apparatus of claim 13, wherein the consumable article comprises:
at least one guide groove formed therein to correspond to and receive therein the at least one guide protrusion.

15. The image forming apparatus of claim 14, wherein the at least one guide groove receives the at least one guide protrusion during the second directional rotation of the connection unit.

16. The image forming apparatus of claim 14, wherein the at least one connection terminal does not contact the consumable article until at least a portion of the at least one guide protrusion is received within the at least one guide groove.

17. The image forming apparatus of claim 10, wherein the consumable article comprises:
at least one connector to contact the at least one connection terminal to transfer the information from the consumable article to the main body.

18. The image forming apparatus of claim 10, wherein the rotations of the connection unit in the first and second directions both occur as the consumable article is pushed in a first installation direction within the main body.

19. The image forming apparatus of claim 10, further comprising:
an elastic member to provide a rotational force to the connection unit such that the connection unit rotates in the second direction and the at least one connection terminal maintains contact with the consumable article after installation of the consumable article within the main body.

20. The image forming apparatus of claim 19, wherein the elastic member is disposed at a first end of the connection unit opposite to a second end at which the connection unit contacts the consumable article.

21. An image forming apparatus, comprising:
a main body;
a connection unit rotatably coupled to the main body, comprising:
at least one connection terminal to receive information to be provided to the main body, and
one of a guide groove and a guide protrusion; and
a consumable article to rotate the connection unit in a first direction during an installation of the consumable article within the main body, the consumable article comprising:
the other one of the guide groove and the guide protrusion, such that the consumable article transfers the information to the at least one connection terminal in response to an insertion of the guide groove into the guide protrusion.

22. The image forming apparatus of claim 21, wherein the insertion of the guide groove into the guide protrusion causes the at least one connection terminal to contact the consumable article.

23. The image forming apparatus of claim 21, wherein the guide groove is inserted into the guide protrusion during a rotation of the connection unit in a second direction.

24. The image forming apparatus of claim 23, wherein the first rotational direction of the connection unit is counter-clockwise and the second rotational direction of the connection unit is clockwise.

25. An image forming apparatus, comprising:
a main body;
a consumable article to be installed within the main body in a first installation direction; and
a connection unit rotatably coupled to the main body, the connection unit comprising;
at least one connection terminal to receive information from the consumable article to be provided to the main body, and
a guide protrusion to prevent the at least one connection terminal from contacting the consumable article until the guide protrusion is received within a guide groove within the consumable article during the installation of the consumable article in the first installation direction.

26. The image forming apparatus of claim 25, wherein the connection unit rotates in a first direction before the guide protrusion is received within the guide groove and rotates in a second direction in response to the guide protrusion being received within the guide groove.
